(19) United States
(12) Patent Application Publication
(10) Pub. No.: US 2018/0057312 A1
(43) Pub. Date: Mar. 1, 2018

(54) BUILDING OCCUPANT EVACUATION

(71) Applicant: OTIS ELEVATOR COMPANY, Farmington, CT (US)

(72) Inventors: Ronnie E. Thebeau, Haddam, CT (US); Jannah A. Stanley, Portland, CT (US); David M. Hughes, East Hampton, CT (US); James M. Collins, Burlington, CT (US); Paul A. Stranieri, Bristol, CT (US)

(21) Appl. No.: 15/248,644

(22) Filed: Aug. 26, 2016

(51) Int. Cl. B66B 5/02; B66B 1/24; B66B 9/00; B66B 1/46; B66B 3/00

(52) U.S. Cl. CPC B66B 5/021; B66B 1/24; B66B 2201/4653; B66B 1/468; B66B 3/002; B66B 9/00

(57) ABSTRACT

An elevator system includes at least one elevator car movable between a plurality of landings. The elevator system is operable in an occupant evacuation operation mode. In the occupant evacuation operation mode, at least one safe room is associated with at least one of the plurality of landings.

### BACKGROUND

Embodiments generally relate to an elevator system, and more particularly, to an elevator system operable in an evacuation mode for emptying a building during an emergency event.

In conventional elevator systems, when a disaster or emergency occurs in a building, each elevator car travels to the nearest floor and typically prohibits subsequent operations. In newer construction, information available to the elevator system and to other resources of the building has been greatly improved. As a result, it is desirable to continue operation of the elevators, such as to floors that have been identified as being affected by the emergency event, to assist in evacuating occupants from the building.

### SUMMARY

According to an embodiment, an elevator system includes at least one elevator car movable between a plurality of landings. The elevator system is operable in an occupant evacuation operation mode. In the occupant evacuation operation mode, at least one safe room is associated with at least one of the plurality of landings.

In addition to one or more of the features described above, or as an alternative, in further embodiments a plurality of safe rooms are associated with the plurality of landings.

In addition to one or more of the features described above, or as an alternative, in further embodiments a plurality of safe rooms are associated with one of the plurality of landings.

In addition to one or more of the features described above, or as an alternative, in further embodiments the at least one safe room includes a user interface for placing a hall call to the elevator system.

In addition to one or more of the features described above, or as an alternative, in further embodiments the user interface is capable of communicating a total number of occupants within the safe room to the elevator system.

In addition to one or more of the features described above, or as an alternative, in further embodiments the user interface is operable only when the elevator system is in the occupant evacuation operation mode.

In addition to one or more of the features described above, or as an alternative, in further embodiments the user interface is dedicated interface solely for use with the elevator system.

In addition to one or more of the features described above, or as an alternative, in further embodiments the user interface is a multipurpose item.

In addition to one or more of the features described above, or as an alternative, in further embodiments the user interface is one of a computer and a smart device.

In addition to one or more of the features described above, or as an alternative, in further embodiments the at least one safe room includes at least one indicator for providing a status of the elevator system.

In addition to one or more of the features described above, or as an alternative, in further embodiments the at least one safe room includes a monitoring mechanism for providing a status of the at least one safe room.

In addition to one or more of the features described above, or as an alternative, in further embodiments the monitoring mechanism is configured to detect a state of distress within the safe room.

In addition to one or more of the features described above, or as an alternative, in further embodiments operation of the elevator system in the occupant evacuation operation mode is initiated in response to detection of a predefined emergency event.

In addition to one or more of the features described above, or as an alternative, in further embodiments initiation of operation in the occupant evacuation operation mode occurs automatically.

In addition to one or more of the features described above, or as an alternative, in further embodiments initiation of operation in the occupant evacuation operation mode occurs manually.

According to another embodiment, a method of evacuating a building using an elevator system includes initiating operation of the elevator system in an occupant evacuation operational mode, receiving at least one hall call from a safe room, the safe room being associated with one of a plurality of landings of the elevator system when the elevator system is in the occupant evacuation operational mode, and dispatching an elevator car of the elevator system in response to the at least one hall call.

In addition to one or more of the features described above, or as an alternative, in further embodiments initiating operation of the elevator system in the occupant evacuation operational mode occurs automatically in response to detection of a predetermined emergency event.

In addition to one or more of the features described above, or as an alternative, in further embodiments initiating operation of the elevator system in the occupant evacuation operational mode occurs in response to a manual input to the elevator system.

In addition to one or more of the features described above, or as an alternative, in further embodiments the dispatching of the elevator is a continuously optimized dynamic process.

In addition to one or more of the features described above, or as an alternative, in further embodiments the dynamic process of dispatching the elevator car is based on a current position of the elevator car, the landing associated with the at least one hall call, and a location of a predetermined emergency event.

### BRIEF DESCRIPTION OF THE DRAWINGS

The foregoing and other features, and advantages are apparent from the following detailed description taken in conjunction with the accompanying drawings in which:

FIG. 1 is a perspective view of an exemplary elevator system;

FIG. 2 is a front view of the exemplary elevator system of FIG. 1; and

FIG. 3 is a schematic diagram of a portion of an elevator system according to an embodiment.

The detailed description describes embodiments, together with some of the advantages and features thereof, by way of example with reference to the drawings.

### DETAILED DESCRIPTION

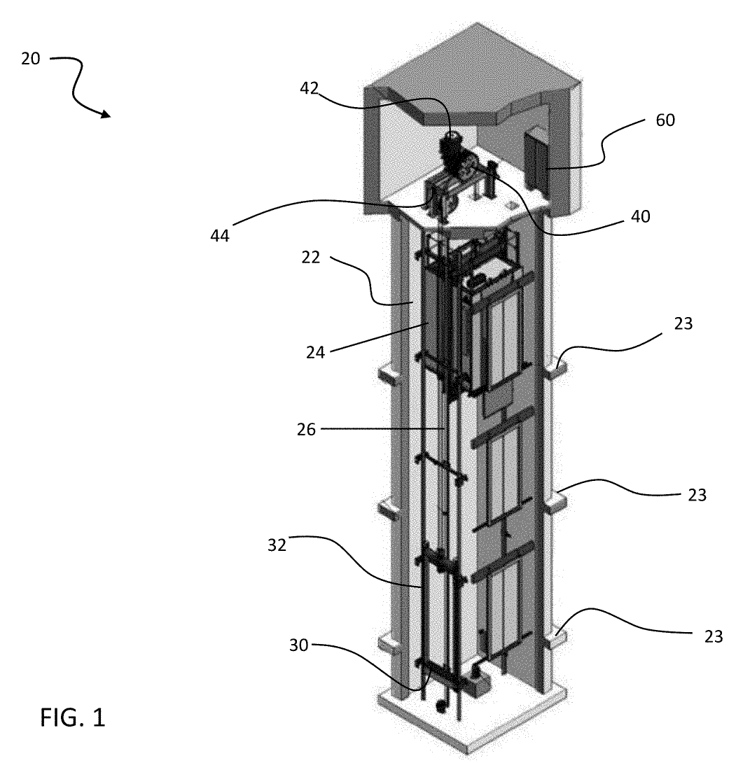

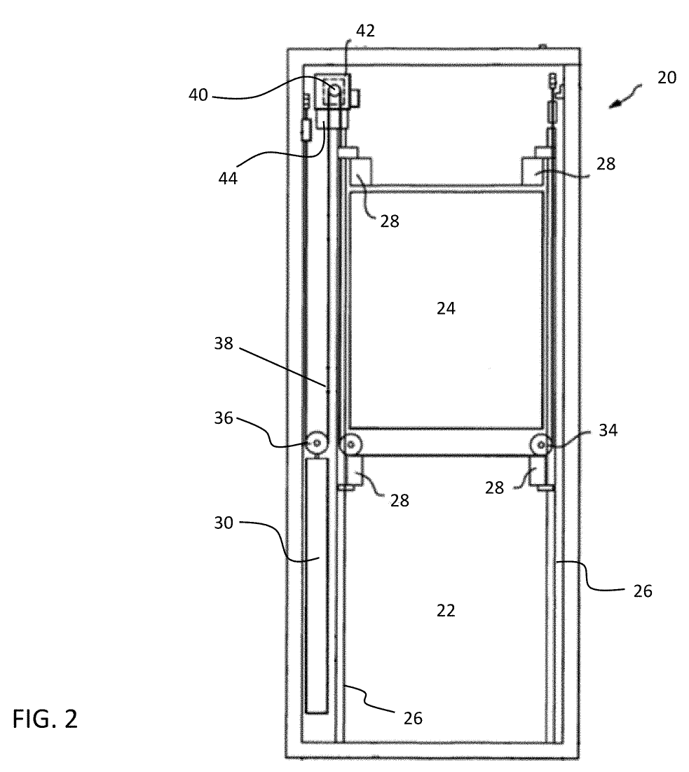

Referring now to FIGS. 1 and 2, an exemplary elevator system 20 is illustrated. The elevator system 20 is located in a building having a plurality of floors. The building includes a hoistway 22 having a plurality of landings 23. Each landing 23 corresponds to one of the plurality of floors. An elevator car 24 is configured to move vertically within the hoistway 22 between the plurality of landings 23 along a plurality of car guide rails 26. Guide assemblies 28 mounted to the top and/or bottom of the elevator car 24 are configured to engage the car guide rails 26 to maintain proper alignment of the elevator car 24 as it moves within the hoistway 22.

The elevator system 20 also includes a counterweight 30 configured to move vertically within the hoistway 22. The term counterweight 30 as used herein includes a counterweight assembly that may itself include various components as would be understood by a person skilled in the art. The counterweight 30 moves in a direction generally opposite the movement of the elevator car 24 as is known in conventional elevator systems. Movement of the counterweight 28 is guided by counterweight guide rails 32 mounted within the hoistway 22. In the illustrated, non-limiting embodiment, the elevator car 24 and counterweight 30 include sheave assemblies 34, 36 that cooperate with tension members 38 and a traction sheave 40. The traction sheave 40 is mounted to a drive machine 42 to raise and lower the elevator car 24. The sheave assembly 34, shown in FIG. 2, is mounted to the bottom of the elevator car 24. However, the sheave assemblies 34 may be mounted at another location on the elevator car 24 or elsewhere in the system 10 as recognized by a person skilled in the art.

The drive machine 42 of the elevator system 20 is positioned and supported at a mounting location atop a support member 44, such as a bedplate for example, in a portion of the hoistway 22 or a machine room. Although the elevator system 20 illustrated and described in herein has an underslung 2:2 roping configuration, elevator systems 20 having other roping configurations and hoistway layouts are within the scope of the disclosure. It should be understood that the elevator system 20 illustrated and described herein is intended as an example only, and other types of elevator systems, such as hydraulic systems for example, are also contemplated herein. In addition, the elevator system 20 illustrated and described herein includes a single elevator car within a single hoistway. Embodiments including multiple elevator cars within one or more hoistways, with or without tension member 38 or hydraulics, are also within the scope of the disclosure.

Operation of conventional elevator systems during an emergency event is typically limited, for example, to rescue personnel, to prevent building occupants from becoming trapped in the elevator car. According to an embodiment, the overall functionality of the elevator system 20 is improved by configuring the elevator system 20 to operate in an occupant evacuation operation mode (also referred to herein as “OEO mode”) after detecting the occurrence of a predefined emergency event. A predefined emergency event may include any potential threat that requires evacuation of the building. Examples of a predefined emergency event that may cause the elevator system 20 to transition from operation in a normal mode to the OEO mode include but are not limited to a fire, an earthquake, a bomb threat, and an active shooter for example. The transition between the normal mode and the OEO mode occurs automatically, such as upon determination of the occurrence of an emergency event by one or more sensors or detectors (not shown) positioned throughout the building for example. Alternatively, or in addition, operation of the elevator system 20 in the OEO mode may be initiated manually, such as in response to an input provided by a user.

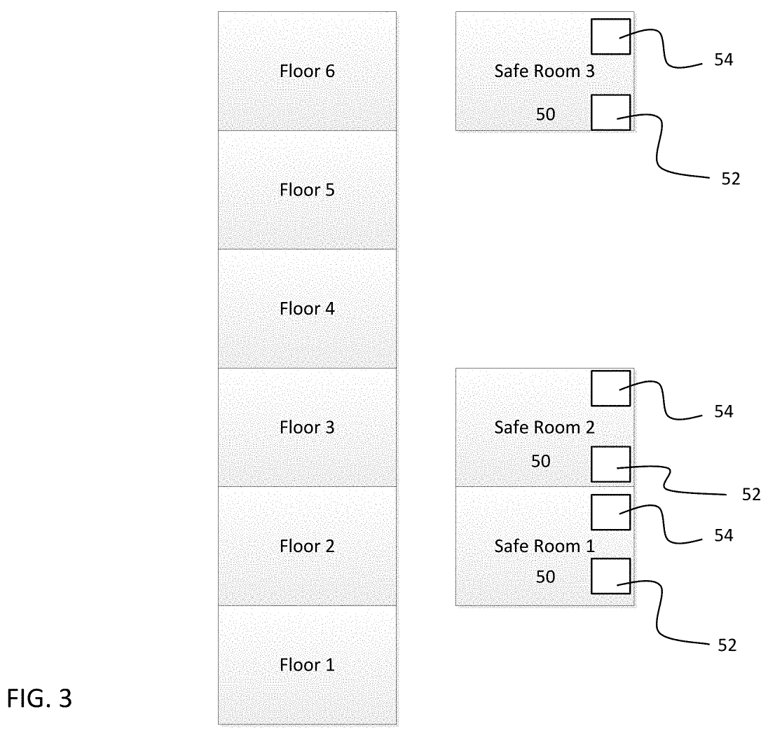

With reference now to FIG. 3, at least one “safe room” 50 is associated with the elevator system 20 when operating in the OEO mode. In the illustrated, non-limiting embodiment, only a portion of the floors of a building have a dedicated safe room 50 located thereon. However, embodiments where every floor of the building includes a safe room 50 or where only a single floor includes a safe room 50 are also possible. In one embodiment, one or more floors may include multiple safe rooms 50.

A safe room 50 is any type of room where nearby occupants of the building are instructed to gather during an emergency event for evacuation by either operation of the elevator system 20 or by emergency personnel. The at least one safe room 50 may, but need not serve another purpose within the building when the elevator system 20 is in a normal operating mode. For example, a room that typically functions as a conference room may behave as the safe room 50 when the elevator system 20 is in OEO mode. In an embodiment, the safe room 50 may provide direct access to a landing 23 of the elevator system 20 associated therewith. However, a safe room 50 arranged at a position within the building away from the hoistway 22 and the corresponding landing 23 is also within the scope of the disclosure.

The occupants within a safe room 50 are able to place a hall call to the elevator system 20. In an embodiment, at least one user interface 52, such as a button, key pad, touch screen, or other input device is positioned within the safe room 50. In one embodiment, the user interface 52 may be a dedicated interface solely for use with the elevator system 20. In one embodiment, the user interface 52 may be a multipurpose item typically found in modern conference rooms. For example, the user interface 52 may be a permanently mounted display located in the safe room 50 such as a “smart device” including, but not limited to, a smartphone, tablet, personal computer, personal digital assistant, badge, television or projector. In one embodiment, the user interface 52 may be a computer in the safe room 52 and communicate with the elevator through an application installed on the computer, a web portal, or any other means. In one embodiment, the user interface 52 may only permit interaction with the elevator system 20 when the elevator system 20 is operating in an OEO mode. Alternatively, the, the user interface 52 located within the safe room 50 may be operable during normal elevator operation and OEO operation.

One or more indicators 54 may be configured to provide the occupants of the safe room 50 with information regarding the status of the elevator system 20. In an embodiment, the at least one user interface 52 may also operate as an indicator 54. For example, the one or more indicators 54 may include a display capable of identifying the current floor at which the elevator car 24 is located and/or provide an indication of when an elevator car 24 of the system 20 has arrived at the landing 23 associated with the safe room 50, or provide an estimate of the amount of time until an elevator car 24 of the system 20 will arrive at the landing 23 associated with the safe room 50. The one or more indicators 54 may alternatively include a speaker configured to provide an announcement regarding the status of the elevator system 20 or may be used to communicate with rescue personnel.

In some embodiments, a camera or other detection device may be positioned within the safe room 50 to provide rescue personnel with a status of the safe room 50 including the number of occupants contained therein. Alternatively or in addition, elevator cars 24 may be dispatched based upon the number of people in the safe room 50 as detected by the camera or other device. In one embodiment, the cameras may automatically detect whether a safe room 50 is in a general state of distress, for example, if there is smoke or fire in the safe room 50, and prioritize evacuation of that safe room 50. The cameras may also be configured to automatically detect whether a particular individual in a safe room 50 is in a state of distress, for example, a medical injury, and prioritize evacuation of that safe room 50. In one embodiment, building, rescue or other personnel may manually detect a state of distress in a safe room 50 by monitoring the video cameras and manually dispatch an elevator car 24 to that safe room 50. While cameras are specifically disclosed, any other known monitoring technology may be used.

When the elevator system 20 operates in the OEO mode, all hall calls placed are communicated to a controller 60 of the elevator system 20 (illustrated schematically in FIG. 1). The controller 60 makes use of the information available, for example the floors where calls have been placed, the number of passengers associated with each call, and a location of the predetermined emergency event, to determine an optimal strategy for dispatching the one or more elevator cars 24 of the system 20 to respond to the plurality of hall calls. In an embodiment, the controller 60 is configured to prioritize hall calls received from a safe room 50 above hall calls placed from a lobby directly adjacent an elevator landing 23. The dispatching of the one or more elevator cars 24 performed by the controller 60 may be a dynamic process that is continuously optimized in view of later placed hall calls and changes in the information available to the system.

The elevator system 20 illustrated and described herein provides the benefit of allowing occupants of the building to “shelter in place” at a predefined location while elevator cars 24 are dispatched. Rescue personnel may utilize the elevator cars 24 to rescue building occupants. In addition, these safe rooms 50 provide a known location where disabled persons can wait for rescue personnel to assist them.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. An elevator system within a building comprising:
at least one elevator car movable between a plurality of landings, wherein the elevator system is operable in an occupant evacuation operation mode, and in the occupant evacuation operation mode, at least one safe room is associated with at least one of the plurality of landings, the at least one safe room having a secondary purpose within the building when the elevator system is in a normal operating mode.

2. The elevator system according to claim 1, wherein a plurality of safe rooms are associated with the plurality of landings.

3. The elevator system according to claim 1, wherein a plurality of safe rooms are associated with one of the plurality of landings.

4. The elevator system according to claim 1, wherein the at least one safe room includes a user interface for placing a hall call to the elevator system.

5. The elevator system according to claim 4, wherein the user interface is capable of communicating a total number of occupants within the at least one safe room to the elevator system.

6. The elevator system according to claim 4, wherein the user interface is operable only when the elevator system is in the occupant evacuation operation mode.

7. The elevator system according to claim 4, wherein the user interface is dedicated interface solely for use with the elevator system.

8. The elevator system according to claim 4, wherein the user interface is a multipurpose item.

9. The elevator system according to claim 8, wherein the user interface is one of a computer and a smart device.

10. The elevator system according to claim 1, wherein the at least one safe room includes at least one indicator for providing a status of the elevator system.

11. The elevator system according to claim 1, wherein the at least one safe room includes a monitoring mechanism for providing a status of the at least one safe room.

12. The elevator system according to claim 11, wherein the monitoring mechanism is configured to detect a state of distress within the at least one safe room.

13. The elevator system according to claim 1, wherein operation of the elevator system in the occupant evacuation operation mode is initiated in response to detection of a predefined emergency event.

14. The elevator system according to claim 13, wherein initiation of operation in the occupant evacuation operation mode occurs automatically.

15. The elevator system according to claim 13, wherein initiation of operation in the occupant evacuation operation mode occurs manually.

16. A method of evacuating a building using an elevator system comprising:
initiating operation of the elevator system in an occupant evacuation operational mode;
receiving at least one hall call from a safe room, the safe room being associated with one of a plurality of landings of the elevator system when the elevator system is in the occupant evacuation operational mode, the at least one safe room having a secondary purpose within the building when the elevator system is in a normal operating mode; and
dispatching an elevator car of the elevator system in response to the at least one hall call.

17. The method of claim 16, wherein initiating operation of the elevator system in the occupant evacuation operational mode occurs automatically in response to detection of a predetermined emergency event.

18. The method of claim 16, wherein initiating operation of the elevator system in the occupant evacuation operational mode occurs in response to a manual input to the elevator system.

19. The method of claim 16, wherein the dispatching of the elevator is a continuously optimized dynamic process.

20. The method according to claim 16, wherein the dynamic process of dispatching the elevator car is based on a current position of the elevator car, a landing associated with the at least one hall call, and a location of a predetermined emergency event.
